(19) United States
(12) Patent Application Publication
(10) Pub. No.: US 2007/0029873 A1
(43) Pub. Date: Feb. 8, 2007

(54) Optimized brake release timing using a quick release valve

(75) Inventor: David W. Howell, Emmaus, PA (US)

Correspondence Address: CALFEE HALTER & GRISWOLD, LLP, 800 SUPERIOR AVENUE, SUITE 1400, CLEVELAND, OH, 44114, US

(73) Assignee: Bendix Commercial Vehicle Systems LLC, Elyria, OH (US)

(21) Appl. No.: 11/194,200

(22) Filed: Aug. 1, 2005

(51) Int. Cl. B60T 8/44

(52) U.S. Cl. 303/114.3; 303/197; 303/3

(57) ABSTRACT

A brake system that uses a quick release valve in place of a double check valve to optimize the timing of the release of pressurized air from the brake chambers and supply lines is provided. The quick-release valve further includes a threaded exhaust port that functions as a second supply port. By using the threaded exhaust port as a second supply port, the diaphragm in the quick release valve acts similar to an unbiased diaphragm double check valve during periods of increasing air pressure, but retains the functionality of a quick release valve during periods of decreasing air pressure by favoring release through the threaded exhaust port.

### BACKGROUND OF THE INVENTION

The present invention relates generally to valves for use with vehicle air brake systems, and more specifically to the use of a quick release valve as a double check for the purpose of optimizing the timing of air brake chamber pressure release.

Air brake systems installed on large vehicles typically utilize pressurized air to operate the brakes of the vehicle. Prior art air brake systems usually include a combination of three different braking systems, namely: the service brakes, the parking brakes, and the emergency brakes. The service brake system applies and releases the brakes when the driver uses the brake pedal during normal driving situations. The parking brake system applies and releases the parking brakes when the parking brake control is actuated. The emergency brake system utilizes portions of the service brake and parking brake systems to stop the vehicle in the event of a brake system failure.

In most air brake systems, when the driver or vehicle operator applies the service brakes by depressing the brake pedal, pressurized air passes through the brake pedal, through a series of valves, and enters the brake chambers to apply the brakes. When the driver or operator releases the brake pedal, the air pressure in the brake chambers is released, thereby de-actuating the service brakes. In certain situations, the inclusion of certain valve types in the air brake system can affect the rate at which air pressure can be released from the brake chambers. More specifically, in brake systems that include double-check valves or valves with similar functionality, the rate at which air pressure is released may be decreased. Limitations on the rate at which pressurized air can be released from the brake chambers are undesirable, especially if federal regulations provide certain time periods within which depressurization is to occur. Thus, there is a need for a valve that provides double-check valve functionality, but that does not reduce or otherwise negatively impact brake release timing.

### SUMMARY OF THE INVENTION

Deficiencies in the prior art are overcome by the present invention, the exemplary embodiment of which provides a system and method for retaining the functionality of a double check valve within an air brake system without limiting the time period within which pressurized air may be released from the service brake chamber(s).

In accordance with one aspect of the present invention, an air brake system that uses a quick release valve in place of a double check valve to optimize the timing of the release of pressurized air from the brake chambers and supply lines is provided. In accordance with a second aspect of this invention a quick-release valve that further includes a threaded exhaust port for functioning as a second supply port is provided. By using the threaded exhaust port as a second supply port, the diaphragm in the quick release valve acts similar to an unbiased diaphragm double check valve during periods of increasing air pressure, but retains the functionality of a quick release valve during periods of decreasing air pressure by favoring release through the threaded exhaust port. A third aspect of this invention includes a method for providing double check valve functionality to an air brake system, which may include an antilock brake system (ABS) component or subsystem, wherein the release timing, i.e., the time in which the air brake releases or de-actuates, is optimized.

Additional features and aspects of the present invention will become apparent to those of ordinary skill in the art upon reading and understanding the following detailed description of the exemplary embodiments. As will be appreciated, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description of the embodiments given below, serve to explain the principles of the invention.

FIG. 1 is a cross sectional view of an exemplary double check valve.

FIG. 2 is a cross sectional view of an exemplary quick release valve.

FIG. 3 is schematic representation of a portion of an exemplary brake system wherein the double check valve has been replaced by a quick release valve.

FIG. 4 is schematic representation of an exemplary ABS brake system wherein the double check valve has been replaced by a quick release valve.

### DETAILED DESCRIPTION OF THE INVENTION

The exemplary embodiment of the present invention provides a method for retaining the function of a double check valve within an air brake system without limiting the time period within which pressurized air may be released from the service brake chambers. A first embodiment of the present invention provides an air brake system that uses a quick release valve in place of a double check valve to optimize the timing of the release of pressurized air from the brake chambers and supply lines. A second embodiment of this invention provides a quick-release valve that further includes a threaded exhaust port for functioning as a second supply port. By using the threaded exhaust port as a second supply port, the diaphragm in the quick release valve acts similar to an unbiased diaphragm double check valve during periods of increasing air pressure, but retains the functionality of a quick release valve during periods of decreasing air pressure by favoring release through the threaded exhaust port. A third embodiment of this invention provides a method controlling an air brake system and for providing double check valve functionality to the system, which may include an ABS component or subsystem, wherein the release timing, i.e., the time in which the air brake releases or de-actuates, is optimized.

For the purpose of better understanding the present invention, the following discussion of certain components of a typical air brake system on a single-axle tractor and trailer is provided. In a typical air brake system, pressurized air is the primary energy source utilized by the various devices that comprise the system. An engine-driven air compressor provides the pressurized air and a governor typically controls the compressor's output by unloading or cycling it. Reservoirs, three per tractor and, usually, two per trailer, store the compressed air until it is needed to actuate the brakes. The reservoir closest to the compressor is often referred to as a wet tank, because atmospheric moisture tends to condense in this tank. Check valves are used to prevent pressurized air in the primary and secondary reservoirs from passing back through the compressor when the compressor is not running.

The control system component of an air brake system usually consists of a series of pneumatic valves that direct air and control the pressure delivered to certain brake system components. The main valve is the dual-control foot valve, so called because it is actually two valves that operate simultaneously, in response to input from the driver's foot at the brake pedal. Two valves are included because, downstream from the wet tank output, the system splits into two separate brake circuits. Air downstream of the wet tank is divided between primary and secondary reservoirs. The split system ensures that, in the event of a failure, the entire system will not become inoperative, and the truck can be brought to a controlled stop.

When the brake pedal is depressed, pressurized air flows from the primary reservoir and through the primary portion of the dual-control foot valve and actuates the rear axle brakes. Simultaneously, pressurized air flows from the secondary reservoir, through the secondary portion of the dual-control foot valve, to actuate the front axle brakes. A two-way or double check valve senses primary and secondary supply pressure, and allows the dominant pressure to actuate the trailer brakes. Primary air can also be manually supplied to the trailer by means of a hand valve, usually located on or near the steering column. Two-way check valves are also used to allow dominant pressure to activate the stop light switch, and to release the parking brakes.

After the vehicle has been stopped, when the driver lifts his foot from the brake pedal, a quick release valve allows brake actuation air to be quickly exhausted near the brakes it serves, rather than having to travel back through the supply line. The quick release valve serves as a “T” connector through which air flows to the brake chambers. When the foot valve is released, the air in the chambers is allowed to exhaust quickly through the quick release valve rather than having to return to the foot valve to exhaust, thus speeding brake release time. A quick release valve can quickly exhaust air from the front service brake chambers for faster brake release, or from spring brake chambers for faster parking brake application.

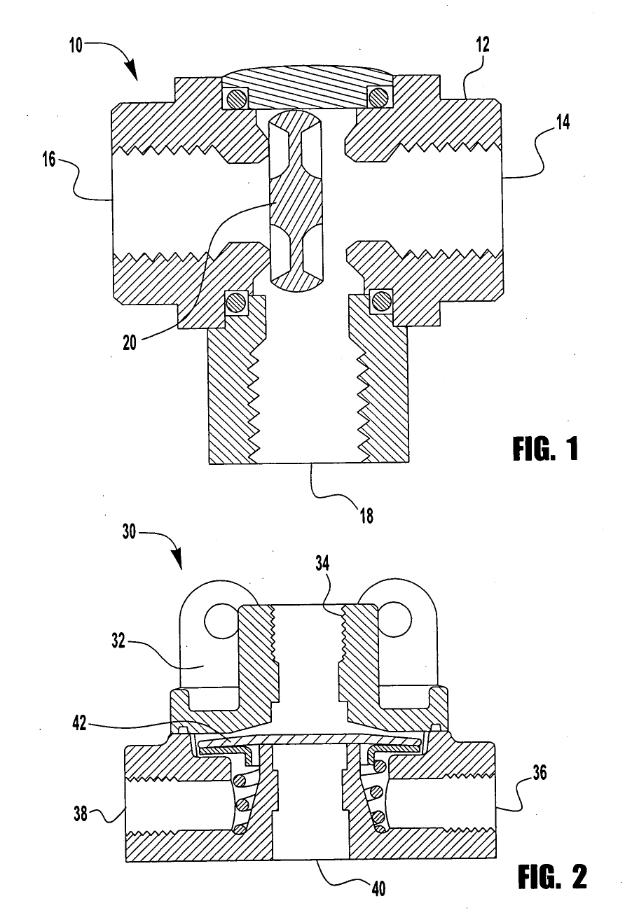

As shown in FIG. 1, a typical double check valve 10 includes a valve body 12, a first supply port 14, a second supply port 16, at least one delivery port 18, and a diaphragm or shuttle 20, or functionally similar device. In an exemplary brake system, a first source of pressurized supply air is connected to first supply port 14, and a second source of pressurized supply air is connected to second supply port 16. When the pressure of the supply air at first supply port 14 exceeds the pressure of the supply air at second supply port 16, shuttle 20 moves within valve body 12 and closes second supply port 16, thereby directing the pressurized air received at first supply port 14 to delivery port 18 and into the service line. Likewise, when the pressure of the supply air at second supply port 16 exceeds the pressure of the supply air at first supply port 14, shuttle 20 moves within valve body 12 and closes first supply port 14, thereby directing the pressurized air received at second supply port 16 to delivery port 18 and into the service line. In this manner, double check valve 10 selects the higher of the two supply air pressures for delivery downstream of the flow of pressurized air through the brake system. When supply pressures within the system fall, a typical double check valve connects delivery port 18 to the higher pressure, which is because it is the higher/greater of the two pressures, will presumably create a lag or take a longer period of time to release the brakes. It is this aspect that makes a typical double check valve an undesirable and unsuitable system device When air brake release timing is important.

With reference to FIG. 2, a typical quick release valve, such as the QR-1 (Bendix Commercial Vehicle Systems LLC, Elyria, Ohio), is utilized to quickly exhaust pressurized air from a vehicle's brake chambers. As shown in FIG. 2, a typical quick release valve 30 includes a valve body 32, a supply port 34, a first delivery port 36, a second delivery port 38, an exhaust port 40, which may by threaded, and a sealing member or diaphragm 42, or functionally similar device. When the operator applies the service brakes, air pressure enters supply port 34, and diaphragm 42 moves down and seals exhaust port 40. At the same time, air pressure forces the edges of diaphragm 42 down and air flows out of the delivery ports. When the supply air is released, the air pressure above diaphragm 42 is released back through the brake valve exhaust port, and air pressure beneath diaphragm 42 forces the diaphragm to rise, thereby opening exhaust port 40 and allowing the delivery air to exhaust from quick release valve 30. Although the QR-1 is compatible with the present invention, essentially any quick release valve in which the exhaust port can be used as a second supply port is suitable for use with this invention.

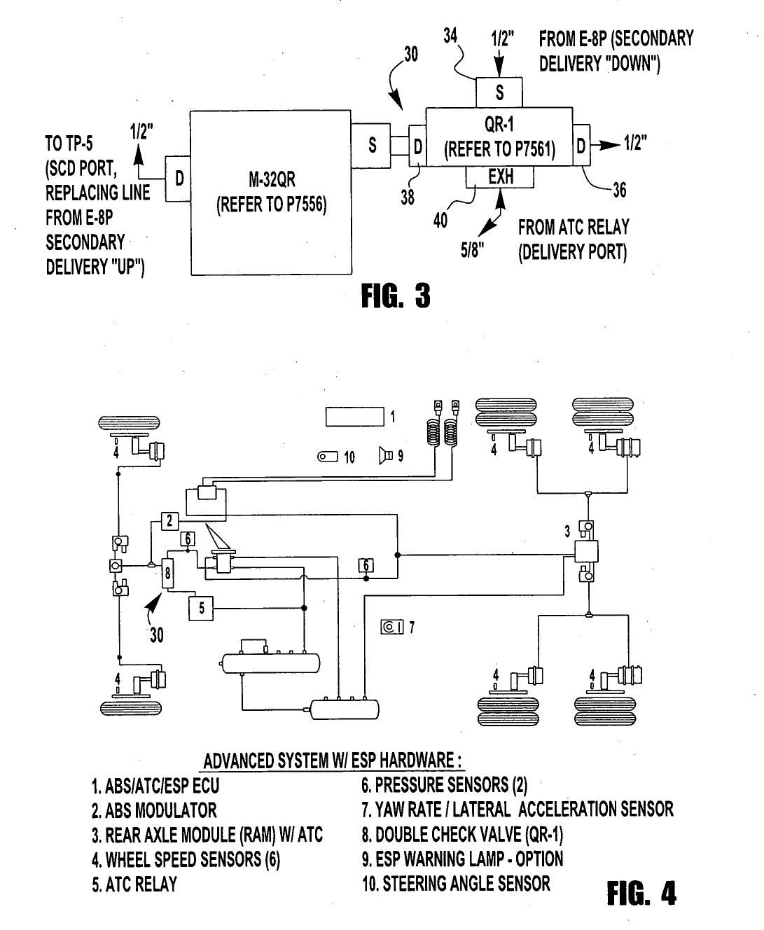

The system and method of the present invention include a quick release valve, such as the QR-1, that is used to replace the double check valve included in certain brake systems (see FIGS. 3 and 4). Due to design characteristics, the quick release valve is capable of functioning as a double check valve. In this manner, double check functionality is retained and release time is optimized. This substitution is most effective in systems where it is known in advance, either through empirical observation, testing, or by design that one supply line is fast to exhaust, but the other supply line may not be without additional devices.

In the exemplary embodiment, the slower to release supply line is connected to supply port 34 of quick release valve 30, and the faster to release supply line is connected to exhaust port 40 of quick release valve 30. When the pressure within the lines is being released, the internal flow characteristics of quick release valve 30 will cause air re-entering quick release valve 30 through delivery ports 36 and 38 to be connected to exhaust port 40, which is connected to the supply line having the higher capacity for releasing the air pressure. Air returning from delivery ports 36 and 38 impinges on one side of diaphragm 42, effectively blowing it toward blocking supply port 34 while opening exhaust port 40. By using exhaust port 40 as a second supply port, quick release valve 30 can act as an unbiased double check when pressure is applied and yet still act as a quick release valve when supply pressures decrease. As previously stated, the supply line that is known to provide the faster preferred exhaust path is connected to the former exhaust port. In this manner, a quick release valve used as a double check valve optimizes the pressure release timing by permitting selection (by design) of the release flow path. By applying the inherent functions of a quick release valve in a double check valve application, some of the most advantageous features of both are used for enhancing release timing and for providing unbiased selection of the higher supply pressure.

In an alternate embodiment, an intentional biasing member is included, in the form of a spring or other means, that favors the exhaust or second supply port, thus creating a differential that must be overcome by pressure at the first supply port to open it for flow to delivery. In another embodiment, a double check quick release valve is used provided it is capable of sufficient flow and exhausting to atmosphere is not undesirable. In still another embodiment, a traditional double check valve is used, in combination with an additional device(s) to aid release timing.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) An air brake system, comprising:
(a) at least two sources of pressurized air, wherein the pressure differs between the at least two sources;
(b) at least one air brake;
(c) a quick release valve in communication with the at least two sources of pressurized air and the at least one air brake;
(d) wherein the quick release valve selects the greater of the at least two pressures and delivers the greater of the at least two pressures to the air brake; and
(e) wherein the air brake is actuated by the greater of the at least two pressures.

2) The air brake system of claim 1, wherein the air brake system further includes an ABS component.

3) The air brake system of claim 1, wherein the quick release valve comprises at least two delivery ports.

4) An air brake system, comprising:
(a) a first source of pressurized air;
(b) a second source of pressurized air;
(c) at least one air brake;
(d) a quick-release valve; wherein the quick release valve further comprises:
(i) a valve body;
(ii) a supply port;
(iii) at least one delivery port in communication with the supply port and the at least one air brake;
(iv) an exhaust port in communication with the first and second delivery ports; and
(v) a sealing member disposed within the valve body between the supply port and exhaust port; and
(e) a first supply line for connecting the first source of pressurized air to the supply port;
(f) a second supply line for connecting the second source of pressurized air to the exhaust port;
(g) wherein the pressure from the first source of pressurized air differs from the pressure from the second source of pressurized air;
(h) wherein the sealing member moves within the valve body in response to the greater of the pressures and connects the supply port with the delivery ports; and
(i) wherein the pressurized air from the delivery ports actuates the at least one air brake.

5) The air brake system of claim 4, wherein the at least one air brake is released by exhausting the pressurized air from the at least one brake through the quick release valve and the first and second brake lines, and wherein the rate of release differs between the supply lines, and wherein the slower to release supply line is connected to the supply port and the faster to release supply line is connected to the exhaust port.

6) The air brake system of claim 5, wherein pressurized air being exhausted from the at least one air brake enters the at least one delivery port, moves the sealing member within the valve body to close the supply port and open the exhaust port.

7) The air brake system of claim 4, wherein the air brake system further includes an ABS component.

8) The air brake system of claim 4, wherein the air brake system further includes at least one relay between the first or second source of pressurized air and the quick release valve.

9) The air brake system of claim 4, wherein the quick release valve comprises at least two delivery ports.

10) The air brake system of claim 4, wherein the exhaust port is threaded.

11) The air brake system of claim 4, wherein the sealing member is a diaphragm.

12) A method for controlling an air brake system, comprising:
(a) providing a first source of pressurized air;
(b) providing a second source of pressurized air;
(c) providing at least one air brake;
(d) providing a quick-release valve; wherein the quick release valve further comprises:
(i) a valve body;
(ii) a supply port;
(iii) at least one delivery port in communication with the supply port and the at least one air brake;
(iv) an exhaust port in communication with the first and second delivery ports; and
(v) a sealing member disposed within the valve body between the supply port and exhaust port; and
(e) connecting the first source of pressurized air to the supply port using a first supply line;
(f) connecting the second source of pressurized air to the exhaust port using a second supply line;
(g) wherein the pressure from the first source of pressurized air differs from the pressure from the second source of pressurized air;
(h) wherein the sealing member moves within the valve body in response to the greater of the pressures and connects the supply port with the delivery ports; and
(i) wherein the pressurized air from the delivery ports actuates the at least one air brake.

13) The method of claim 12, wherein the at least one air brake is released by exhausting the pressurized air from the at least one brake through the quick release valve and the first and second brake lines, and wherein the rate of release differs between the supply lines, and wherein the slower to release supply line is connected to the supply port and the faster to release supply line is connected to the exhaust port.

14) The method of claim 12, wherein pressurized air being exhausted from the at least one air brake enters the at least one delivery port, moves the sealing member within the valve body to close the supply port and open the exhaust port.

15) The method of claim 12, wherein the air brake system further includes an ABS component.

16) The method of claim 12, wherein the air brake system further includes at least one relay between the first or second source of pressurized air and the quick release valve.

17) The method of claim 12, wherein the quick release valve comprises at least two delivery ports.

18) The method of system of claim 12, wherein the exhaust port is threaded.

19) The method of claim 12, wherein the sealing member is a diaphragm.

20) The method of claim 12, wherein the sealing member is a shuttle.

21) An air brake system, comprising:
(a) a first source of pressurized air;
(b) a second source of pressurized air;
(c) at least one air brake;
(d) a quick-release valve; wherein the quick release valve further comprises:
(i) a valve body;
(ii) a supply port;
(iii) at least one delivery port in communication with the supply port and the at least one air brake;
(iv) an exhaust port in communication with the first and second delivery ports; and
(v) a sealing member disposed within the valve body between the supply port and exhaust port; and
(e) a first supply line for connecting the first source of pressurized air to the supply port;
(f) a second supply line for connecting the second source of pressurized air to the exhaust port;
(g) wherein the pressure from the first source of pressurized air differs from the pressure from the second source of pressurized air;
(h) wherein the sealing member moves within the valve body in response to the greater of the pressures and connects the supply port with the delivery ports; and
(i) wherein the pressurized air from the delivery ports actuates the at least one air brake; and wherein the at least one air brake is released by exhausting the pressurized air from the at least one brake through the quick release valve and the first and second brake lines, and wherein the rate of release differs between the supply lines, and wherein the slower to release supply line is connected to the supply port and the faster to release supply line is connected to the exhaust port.

22) The air brake system of claim 21, wherein pressurized air being exhausted from the at least one air brake enters the at least one delivery port, moves the sealing member within the valve body to close the supply port and open the exhaust port.

23) The air brake system of claim 21, wherein the air brake system further includes an ABS component.

24) The air brake system of claim 21, wherein the air brake system further includes at least one relay between the first or second source of pressurized air and the quick release valve.

25) The air brake system of claim 21, wherein the quick release valve comprises at least two delivery ports.

26) The air brake system of claim 21, wherein the exhaust port is threaded.

27) The air brake system of claim 21, wherein the sealing member is a diaphragm.

28) The method of claim 21, wherein the sealing member is a shuttle.
